(19) United States
(12) Patent Application Publication
(10) Pub. No.: US 2006/0210073 A1
(43) Pub. Date: Sep. 21, 2006

(54) Method for predicting when mail is received by a recipient

(75) Inventors: John W. Rojas, Norwalk, CT (US); John H. Winkelman, Southbury, CT (US); Kenneth G. Miller, Bethel, CT (US); Alla Tsipenyuk, Woodbridge, CT (US); James R Norris JR., Danbury, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/373,557

(22) Filed: Mar. 10, 2006

Related U.S. Application Data
(60) Provisional application No. 60/663,027, filed on Mar. 18, 2005.

(51) Int. Cl. G09C 3/08

(52) U.S. Cl. 380/51

(57) ABSTRACT

A method utilizing a computer to predict what volumes of mail will arrive at a given destination on a given date. The method is accomplished by: utilizing the composition of a mailing campaign that contains a plurality of mailing shipments that contain a plurality of containers containing a plurality of mail pieces; making a prediction curve for each container when the shipment is inducted at a carrier facility; and building a mailing campaign prediction based upon the container predictions; wherein each shipment prediction curve is added to the mailing campaign prediction at the date when the shipment is inducted at the carrier facility.

This Application claims the benefit of the filing date of U.S. Provisional Application No. 60/663,027 filed Mar. 18, 2005, which is owned by the assignee of the present Application.

### CROSS REFERENCE TO RELATED APPLICATIONS

Reference is made to commonly assigned co-pending patent application Docket No. F-986-O2 filed herewith entitled “Method for controlling When Mail Is Received By A Recipient” in the names of James R. Norris, Jr., John H. Winkelman, Kenneth G. Miller, John W. Rojas and Alla Tsipenyuk. Docket No. F-986-O3 filed herewith entitled “Method For Predicting Call Center Volumes” in the names of Kenneth G. Miller, John H. Winkelman, John W. Rojas, Alla Tsipenyuk and James R. Norris, Jr. Docket No. F-986-O4 filed herewith entitled, “Method for Dynamically Controlling Call Center Volumes,” in the names of Alla Tsipenyuk, John H. Winkelman, John W. Rojas, Kenneth G. Miller and James R. Norris, Jr. Docket No. F-986-O5 filed herewith entitled, “Method for Determining the best Day of the week For a Recipient to receive a mail piece,” in the names of John H. Winkelman, John W. Rojas, Kenneth G. Miller, Alla Tsipenyuk and James R. Norris, Jr.

### FIELD OF THE INVENTION

This invention relates to predicting the delivery date of mail and more particularly to predicting a mailing's daily recipient delivery distribution volumes using a mailing's shipment container, mail piece level data, historical USPS processing and delivery data, USPS facility processing status data, and shipment processing data.

### BACKGROUND OF THE INVENTION

Direct marketers have used the mail to sell products to customers for almost as long as there has been mail. For direct marketers the USPS is viewed as a black box where the time required to process and deliver the mail is based on guess work and rule of thumb. Where First class mail has delivery standards associated with it, Standard class mail does not. For most of the country First class mail will be processed and delivered within three days. Once the USPS accepts Standard mail the time to process and deliver the mail will be from 1 to 14+ days. Direct marketers have learned to live with this lack of real knowledge of when a mailing will be delivered in home. A disadvantage of the prior art is that direct marketers use rule of thumb to determine in home date range for a mailing, which is not very accurate. One of the methods used is to base in home volumes on when the mailing was shipped from the mail production facility to the USPS induction facility, i.e. when the mailing dropped. In home volumes would be so many days after the mailing dropped, such as from 1 to 10 days from the mailing drop date.

Another method used is to add seeds to the mailing to determine when the seeded mail is delivered and assign that delivery date to all the mail going to that destination city, state or all the mail in the tray the seed is in. Seeding involves sending a mail piece to a known address of a service firm and having the firm date stamp the mail piece and send the mail piece back to the direct mail marketer. A large number of seeds would be 200 or so which is not enough to cover the 350 USPS Destination Sectional Control Facilities in the United States. The direct mail marketer then infers the in-home dates for the mailing as a whole by correlating the shipment date of the mail (when it leaves the letter shop) and when the seed indicated that they received the mail piece. The direct mail marketer then assumes that all mail going to the area that the seed is in arrives on the same day or on some window around the seed date.

Another problem is mail going to that destination or in the tray will be delivered over multiple days where as the seed will only give a point in time and not a date range.

### SUMMARY OF THE INVENTION

This invention overcomes the disadvantages of the prior art by enabling the mailer to know what volumes of mail arrive at a recipient's home or place of business on a given date. This also enables the mailer to determine who received the mail. The foregoing is accomplished by determining the composition of the mailing shipment; determining for each shipment the number of days from the start of the mailing to the induction at the USPS facility, or other carrier facility, i.e., Federal Express, United Parcel Service, DHL, etc.; for each shipment retrieve the container for that shipment; for each container, retrieve the prediction curve for that container; build a shipment prediction based on many container predictions; wherein each shipment prediction curve is added to the mailing at the date when the shipment is inducted at the USPS facility so that a campaign prediction may be built based upon the many shipment predictions.

An advantage of the foregoing is that it enables the mailer to know when their prospective recipient's are most likely to receive a mail piece. The foregoing helps the mailer's staffing and coordination with other channels, i.e., enables the mailer to make follow up phone calls to recipients.

An advantage of this invention is that it accounts for seasonal variability in mail delivery performance based upon USPS staffing and system loading.

An additional advantage this invention is that it accounts for the sortation density of all trays of mail within the mailing.

A further advantage of this invention is that it accounts for where the mail is going in terms of destination zip codes and USPS performance against those zip codes.

A still further advantage of this invention is that it accounts for and adjust expected in home or place of business curves for non-controllable circumstances such as natural events or national security issues.

This invention also takes into consideration: the impact that private logistics companies have on trucking, storing and ultimately inducting standard ‘A’ mail; the impact that when the USPS will actually accept truck loads of mail from high volume mailers; the shape, weight and format of the mail; and the conformance of the mail to USPS automation processing standards.

### BRIEF DESCRIPTION OF THE DRAWINGS

FIG. 1 is a flow chart of a prior art direct mail marketing process;

FIG. 2 is a flow chart showing how to predict recipient delivery distribution for a mailing;

FIG. 3 is a flow chart that generates the actual mail shipment induction date and triggers a prediction update.

FIG. 4 is a flow chart that loads facility conditions and status information and triggers prediction updates if changes are detected.

FIG. 5 is an actual vs. predicted in-home curve for controlled mailing.

FIG. 6 is a drawing showing the predicted vs. partial actual in-home curves for a controlled mailing.

FIG. 7A is a mailing facility condition plant report.

FIG. 7B is a mailing facility loading plant report.

FIG. 8 is a flow chart showing how to compile historic USPS container level delivery data.

FIG. 9A is a drawing showing curves generated for the Dallas Tex. BMC.

FIG. 9B is a drawing showing curves generated for the Denver Colo. BMC.

FIG. 9C is a drawing showing curves generated for the Los Angles Calif. BMC.

FIGS. 10A-10F is a table showing sample mail piece historic delivery times for the North Metro facility which is used to create container level data shown in step 1580 (FIG. 8).

FIGS. 11A-11D depicts sample data representative of the mailing container level data shown in step 1580 (FIG. 8) in tabular form.

FIG. 12 is a flow chart showing how to determine the in-home date for a mail piece.

FIGS. 13A-13B is a table of drop shipment appointment close out dates.

### DETAILED DESCRIPTION OF THE INVENTION

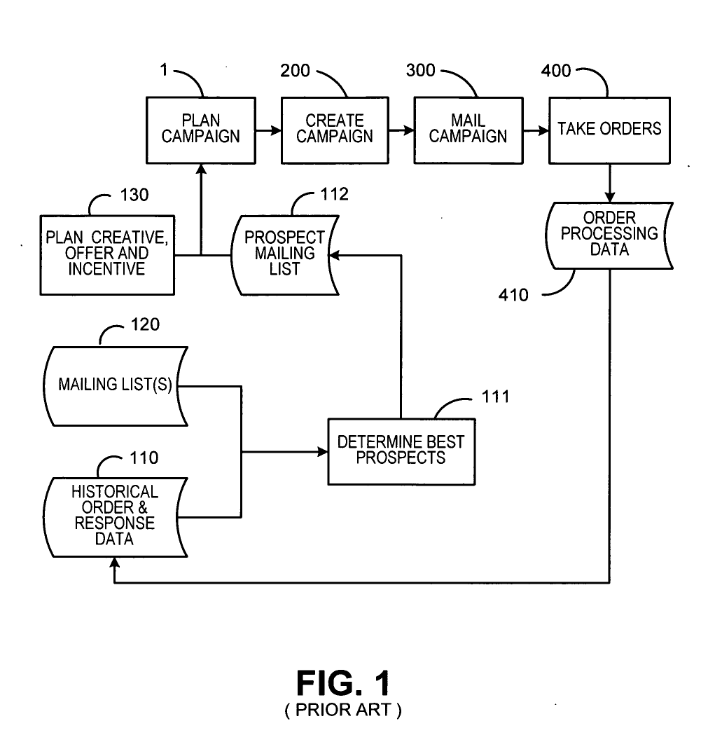

Referring now to the drawings in detail and, more particularly, to Prior Art FIG. 1, the process begins in step 1, where the direct mail marketer plans the campaign. Inputs into campaign planning include planning the creative, i.e., the design of the mail piece, offer and incentive in step 130 and acquiring mailing lists in step 120; then selecting prospects in step 112 by comparing respondent profiles in step 111 from different marketing tests, i.e., previous campaigns in step 110. Once the marketer has created the artwork, selected the prospects to be mailed from the lists available, the campaign is actually created in step 200. Step 200 involves having the various components of the mailing campaign printed, assembled and printing the addresses on the mail pieces and the address presorted. From there, the direct mail marketer mails, i.e., drop ships the mail to the appropriate USPS facility, the offer to all prospective customers in step 300. Once the prospective customers receive the offer, some prospects place orders in step 400. When the prospect orders, the direct mail marketer captures order processing data in step 410 and correlates the data with demographic information. That data is fed back into the order history database in step 110 and used to profile prospective customers for upcoming campaigns.

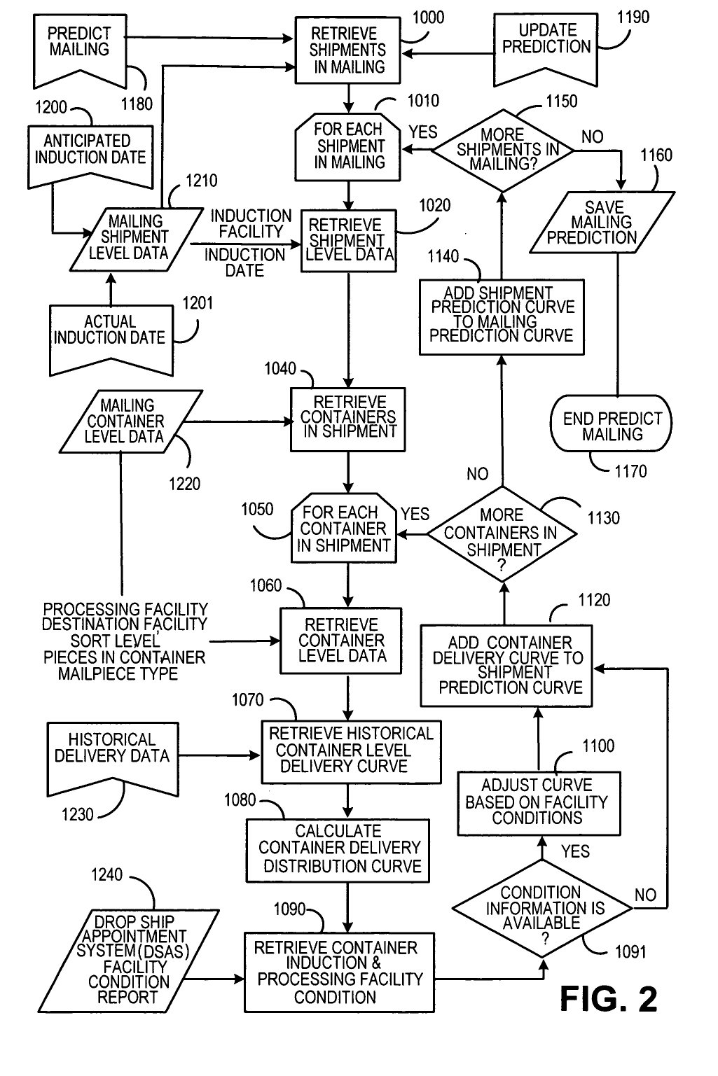

FIG. 2 is a flow chart showing how to predict recipient delivery distribution for a mailing. The process begins in step 1180 where the mailing prediction process begins and goes to retrieve shipments in mailing step 1000 or the process may also begin if it is triggered by the update prediction of step 1190. The anticipated induction date of the mailing from step 1200 is used with the retrieve shipment level data in step 1020 and with the mailing container level data from step 1220 by step 1210 to obtain the mailing shipment level data. Step 1020 uses mailing shipment level data from step 1210 including the anticipated induction date in step 1200 and the induction facility to prepare a prediction for a shipment. In step 1040 the containers in the shipment are retrieved.

In step 1050 the process iterates through each container in the shipment and in step 1060 the process retrieves the container level data. Then the process will go to step 1070 to retrieve a historical container level delivery curve from step 1230. Then in step 1080 the container delivery distribution is calculated based upon the historical delivery curve by applying the container piece count for each day in the distribution and using Sundays, holidays and other postal delivery processing exceptions. Then in step 1090 the information from step 1080 and the drop ship appointment facility condition data from step 1240 is utilized to retrieve container induction and processing facility condition. Step 1091 determines whether or not the information from step 1240 is available. If step 1091 determines the information is available the next step in the process is step 1100 to calculate facility condition offset. If step 1091 determines the information is not available the next step in the process is step 1120.

Then step 1120 adds the container delivery curve to the shipment prediction curve. Then if step 1130 determines that there are no more containers in the shipment, the process goes to step 1140 to add a shipment prediction curve to a mailing prediction curve. If step 1130 determines that there are more containers in the shipment the next step will be step 1050. Now if step 1150 determines that there are no more shipments in the mailing the next step will be step 1160 to save the mailing prediction. If step 1150 determines that there are more shipments in the mailing the next step will be step 1010. Step 1170 ends the predict mailing process.

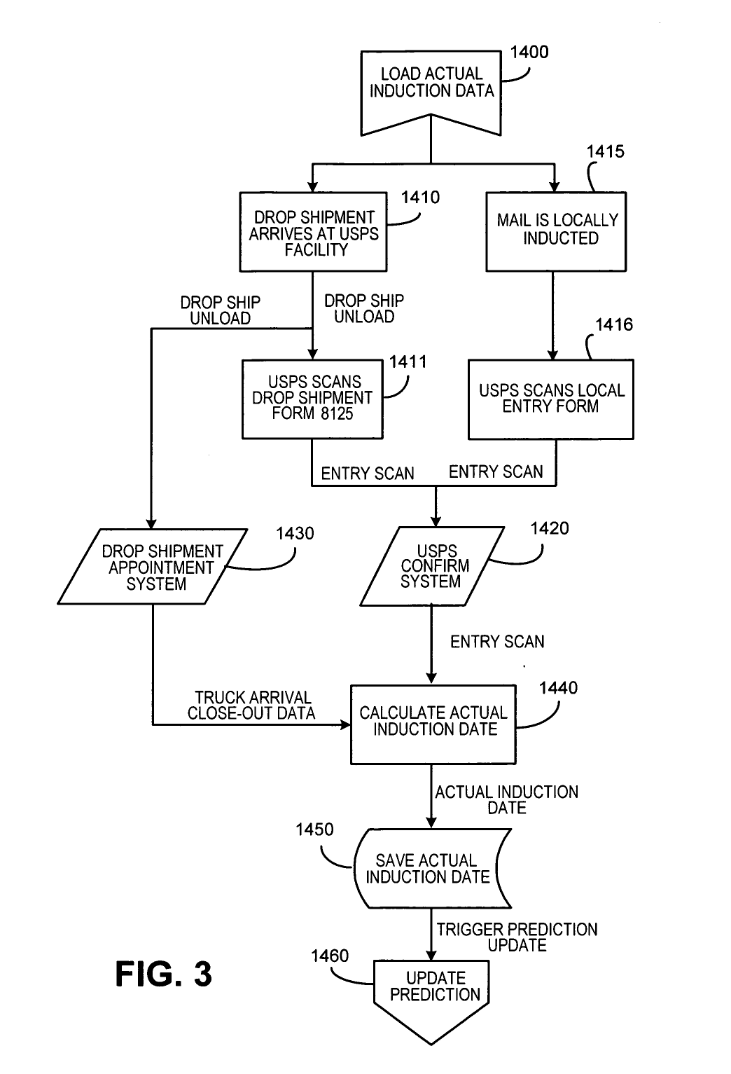

FIG. 3 is a flow chart that generates the actual mail shipment induction date and triggers the prediction update. The process begins at step 1400 via an automated or user driven request. Two independent events are detected, in step 1410, mail arrives at a USPS facility as a Drop Shipment and in step 1415, mail arrives at a USPS facility for local induction. Step 1411 follows step 1410 where the USPS scans Drop Shipment Form 8125 and produces an Entry Scan. Step 1416 follows step 1415 where the USPS scans Local Entry Form 3602 and also produces an Entry Scan. The Entry Scans are stored in Step 1420 by the USPS Confirm System for later retrieval. In addition, step 1410 is also followed by step 1430, where the Drop Shipment Appointment System stores information associated with the drop shipment, such as the truck arrival, status, load time, etc. Step 1420 and step 1430 are followed by Step 1440, where the Actual Induction Date is calculated using the best possible date from the entry scan or the drop shipment information that is available (If both sets of data are available, the appointment data is used). Then in step 1450 the Actual Induction Date is stored and in step 1460 a trigger is generated to update the mailing campaign prediction.

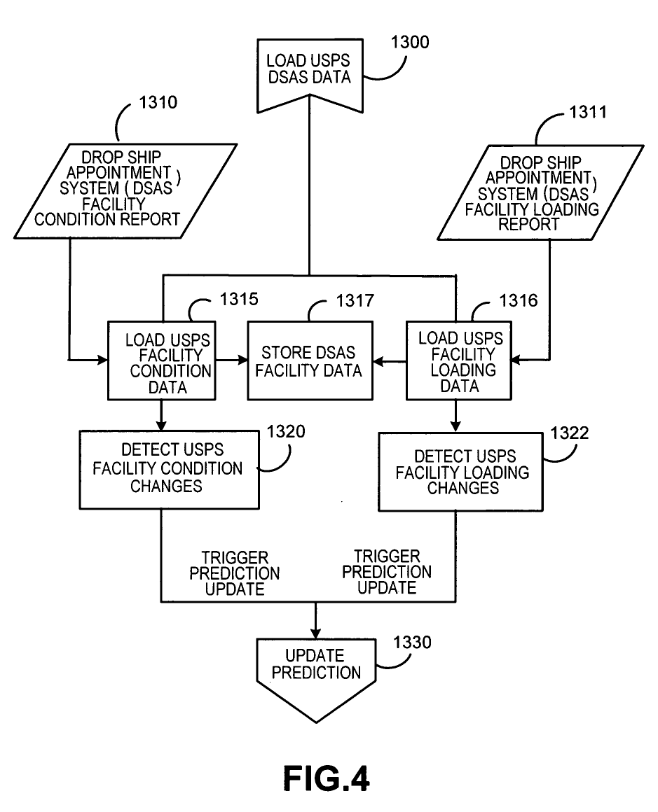

FIG. 4 is a flow chart that loads facility conditions and status information and triggers prediction updates if changes are detected. The process begins at step 1300, via an automated or user driven request. The facility conditions are then loaded in step 1315 from step 1310 and stored in step 1317. At the same time, Facility Loading data is loaded in step 1316 from step 1311 and stored in step 1317. Step 1320 follows step 1315, where changes to the facility conditions are detected. In a similar fashion, step 1322 follows step 1316 and detects changes to the facility loading data. In either case, if changes are detected, steps 1320 and 1322 will trigger a Prediction Update in step 1330.

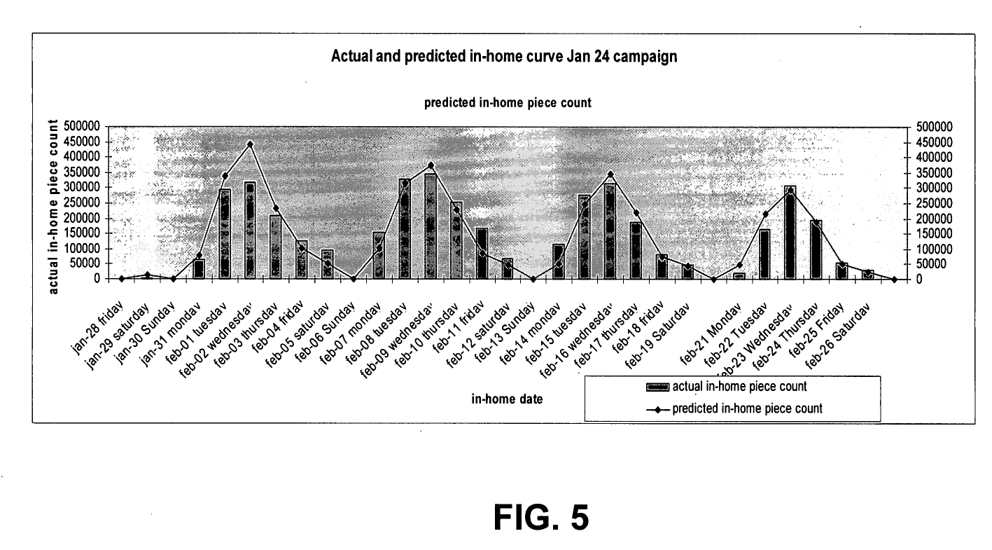

FIG. 5 is an actual vs. predicted in-home curve for controlled mailing.

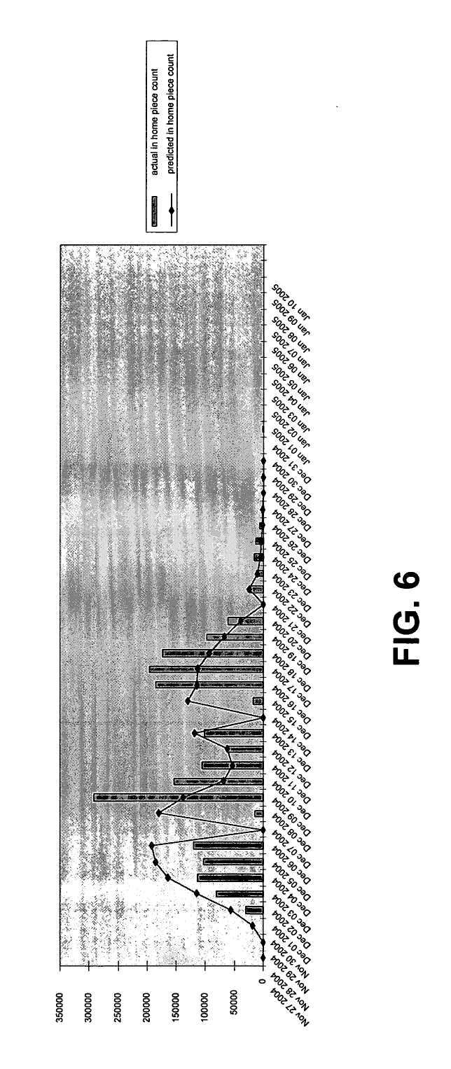

FIG. 6 is a drawing showing the predicted vs. partial actual in-home curves for a controlled mailing.

FIGS. 5 and 6 illustrate the correlation between the mailing campaign prediction and the actual in-home results for a mailing that was controlled to be dropped over a four week period. The Figs. are a visual representation of the predicted mail quantities and dates for two different mailing campaigns. The presented curves represent the aggregation of the predicted in home curve for the shipments belonging to each campaign respectively. Each shipment in home curve prediction is referenced from the scheduled induction date for that shipment.

The expected result was that ¼ of the mail would arrive on Tuesday, Wednesday and Thursday of each week for a period of four weeks. FIG. 5 shows the predicted and actual results after the mailing was completed and FIG. 6 shows how actual results are gathered as the mailing campaign is in progress.

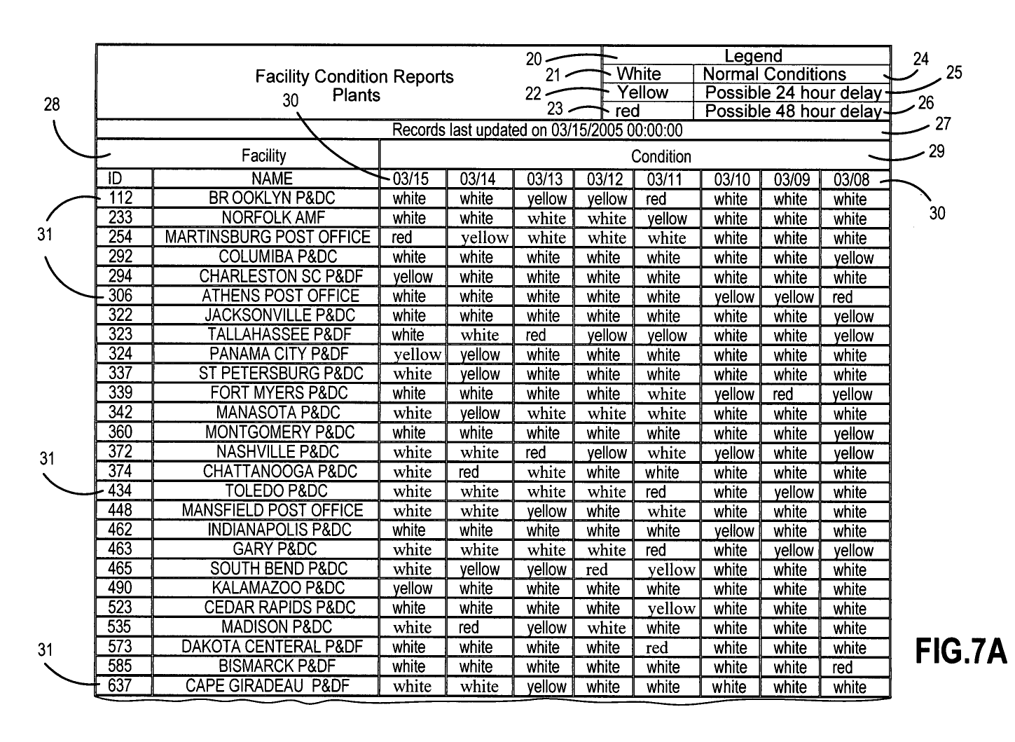

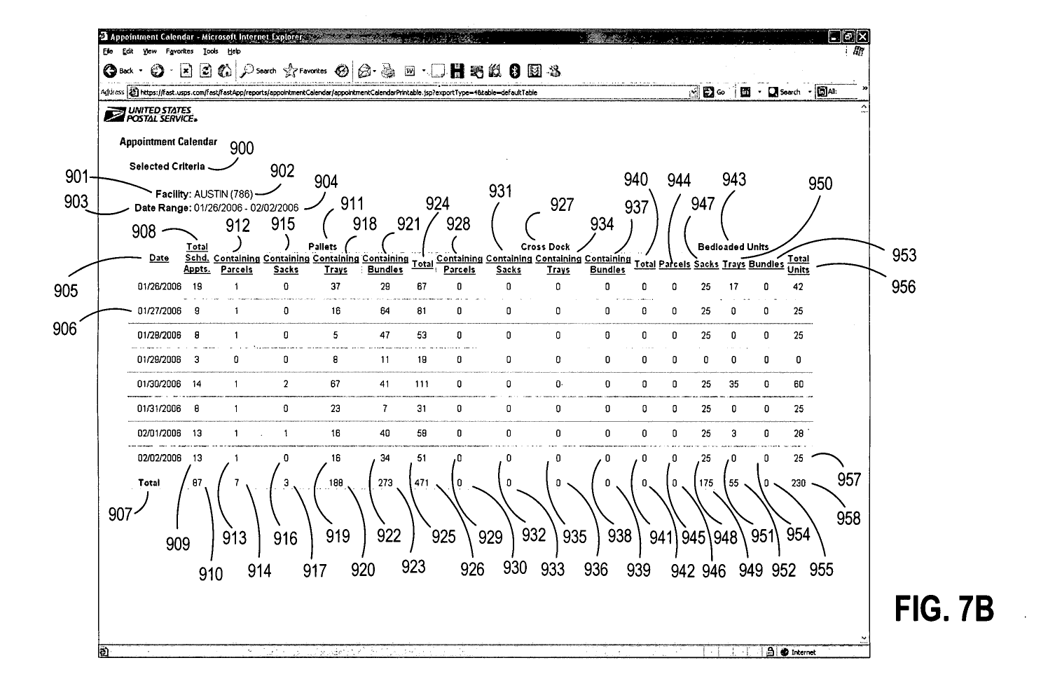

FIG. 7A is a mailing facility condition plant report. Block 20 is the legend block for the report. Spaces 21, 22 and 23 indicate the code used in the report. Space 24 indicates the condition represented by the code indicated in space 21 and space 25 indicates the condition represented by the code indicated in space 22. Space 26 indicates the condition represented by the code indicated in space 23. Space 27 indicates when the report was last updated. Column 28 indicates the facility name and column 29 indicates the condition of the facility indicated in lines 31 shown in rows 30 at the date indicated at the top of the column.

FIG. 7B is a mailing facility loading report that shows facility appointments over a date range. This report provides information on the amount or quantity of mail processed by a specific facility over time and the amount of mail that is scheduled to be processed by a facility in the near future. Space 900 is the header for the search criteria, including space 901 which is the Facility name header and space 902 which is the facility name. Space 903 is the Date Range header and space 904 is the date range for the report.

The data for the report is defined as follows. Space 905 is the column header for the Date and space 906 is date for each row of data.

Space 907 is the row where the Totals are tallied for each column. Space 908 is the header for the Total Scheduled Appointments, and space 909 is the total appointments for each date, and space 910 is the total scheduled appointments for the facility over the date range specified in space 904, Date Range above. Space 911 is the header for the columns related to Pallets scheduled and space 912 is the column header for the total count of pallets containing parcels scheduled and space 913 is the count of pallets containing parcels scheduled for each day. Space 914 is the total count of pallets containing parcels scheduled for all days and space 915 is the column header for the total count of pallets containing bundles scheduled. Space 916 is the count of pallets containing bundles scheduled for each day and space 917 is the total count of pallets containing bundles scheduled for all days.

Space 918 is the column header for the total count of pallets containing trays scheduled and space 919 is the count of pallets containing trays scheduled for each day. Space 920 is the total count of pallets containing trays scheduled for all days. Space 921 is the column header for the total count of pallets containing bundles scheduled. Space 922 is the count of pallets containing bundles scheduled for each day and space 923 is the total count of pallets containing bundles scheduled for all days. Space 924 is the column header for the total count of pallets scheduled and space 925 is the total count of pallets scheduled for each day. Space 926 is the total count of pallets scheduled for all days and space 927 is the header for the columns related to cross docked mail scheduled. Space 928 is the column header for the total count of cross docked mail containing parcels scheduled and space 929 is the count of cross docked mail containing parcels scheduled for each day. Space 930 is the total count of cross docked mail containing parcels scheduled for all days and space 931 is the column header for the total count of cross docked mail containing bundles scheduled. Space 932 is the count of cross docked mail containing bundles scheduled for each day and space 933 is the total count of cross docked mail containing bundles scheduled for all days. Space 934 is the column header for the total count of cross docked mail containing trays scheduled and space 935 is the count of cross docked mail containing trays scheduled for each day. Space 936 is the total count of cross docked mail containing trays scheduled for all days and space 937 is the column header for the total count of cross docked mail containing bundles scheduled. Space 938 is the count of cross docked mail containing bundles scheduled for each day and space 939 is the total count of cross docked mail containing bundles scheduled for all days. Space 940 is the column header for the total count of cross docked mail scheduled and space 941 is the total count of cross docked mail scheduled for each day. Space 942 is the total count of cross docked mail scheduled for all days. Space 943 is the header for the columns related to bed loads scheduled and space 944 is the column header for the total count of bed loads containing parcels scheduled. Space 945 is the count of bed loads containing parcels scheduled for each day and space 946 is the total count of bed loads containing parcels scheduled for all days. Space 947 is the column header for the total count of bed loads containing bundles scheduled and space 948 is the count of bed loads containing bundles scheduled for each day. Space 949 is the total count of bed loads containing bundles scheduled for all days and space 950 is the column header for the total count of bed loads containing trays scheduled. Space 951 is the count of bed loads containing trays scheduled for each day and space 952 is the total count of bed loads containing trays scheduled for all days. Space 953 is the column header for the total count of bed loads containing bundles scheduled and space 954 is the count of bed loads containing bundles scheduled for each day. Space 955 is the total count of bed loads containing bundles scheduled for all days and space 956 is the column header for the total count of bed loads scheduled. Space 957 is the total count of bed loads scheduled for each day and space 958 is the total count of bed loads scheduled for all days.

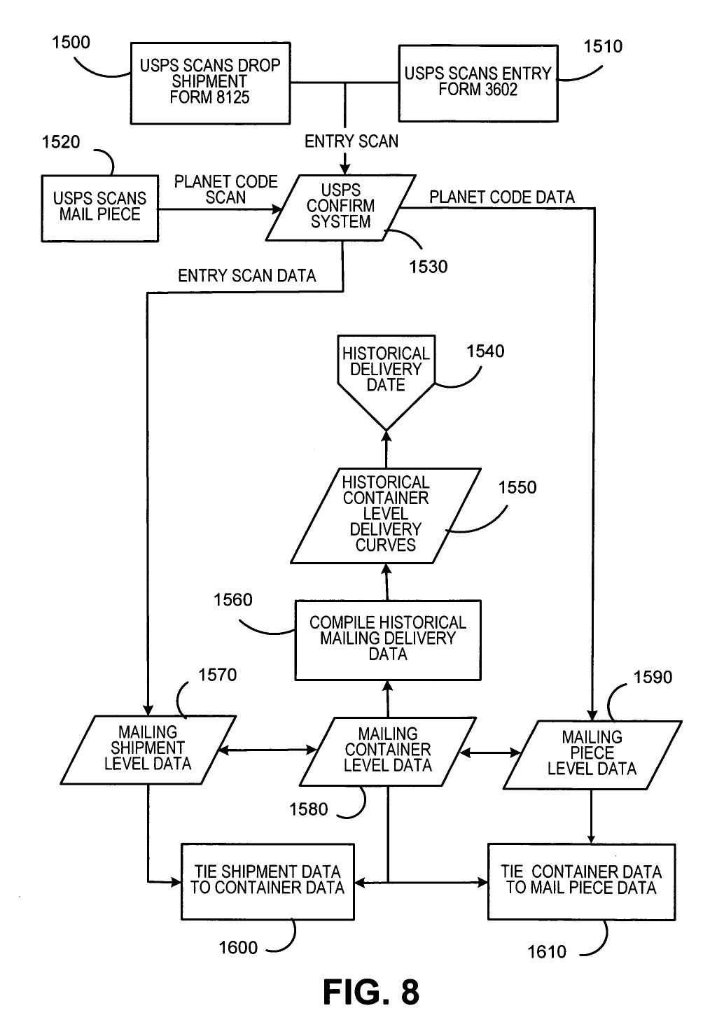

FIG. 8 is a flow chart showing how to compile historic USPS container level delivery data. The process begins at either step 1500 or step 1510. If the process began at step 1500 where the USPS scans drop shipment form 8125. Drop shipment form 8125 is used by the USPS for registering when the drop shipment arrives at a USPS facility. If the process began at step 1510 the USPS scans entry form 3062. Drop shipment form 3062 is used by the USPS for registering when mail is locally inducted by the USPS. In step 1530 the USPS confirm system is utilized. The confirm system receives the information scanned by the USPS from the mail piece in step 1520 and the information from steps 1500 and 1510. Then entry scan data from step 1530 is sent to step 1570 mailing shipment level data and planet code data is sent to step 1590 as mail piece level data. In addition drop shipment close out data is sent from the USPS Drop Shipment Appointment System (DSAS) to step 1570 as mailing shipment level data. In step 1580 mailing container level data is correlated from shipment level data tied in 1600 and mail piece level data tied in step 1610.

Step 1560 utilizes mailing container level data from step 1580 to compile historical mailing delivery data. Step 1550 utilizes historical mailing delivery data from step 1560 to produce historical container level delivery curves. Step 1540 stores the historical delivery data for predicting and/or controlling mailings.

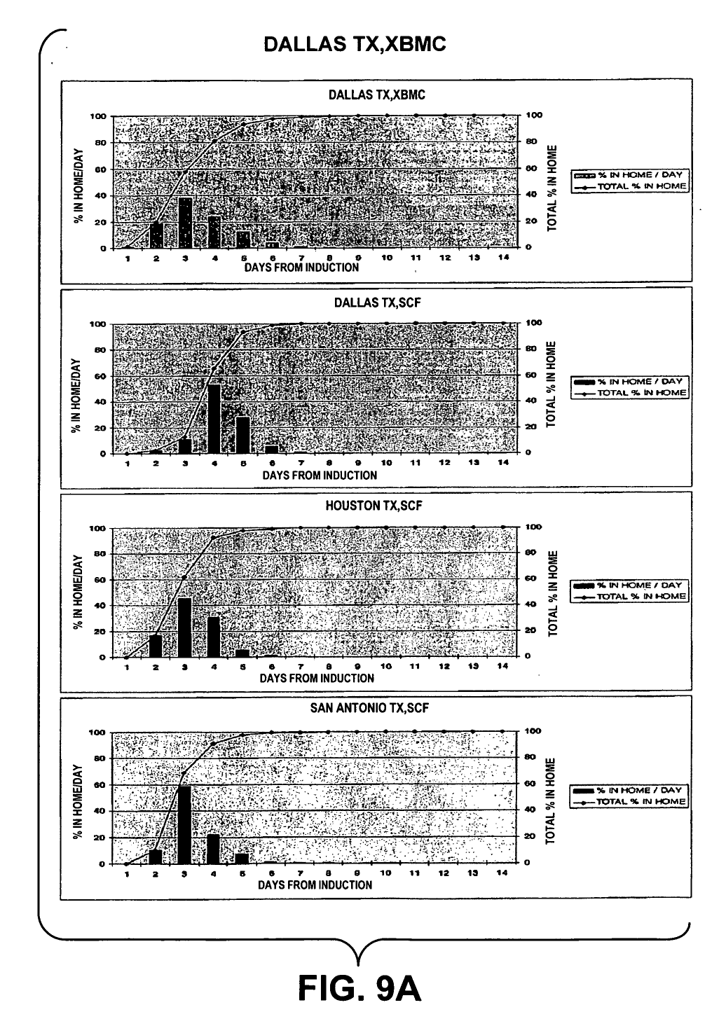

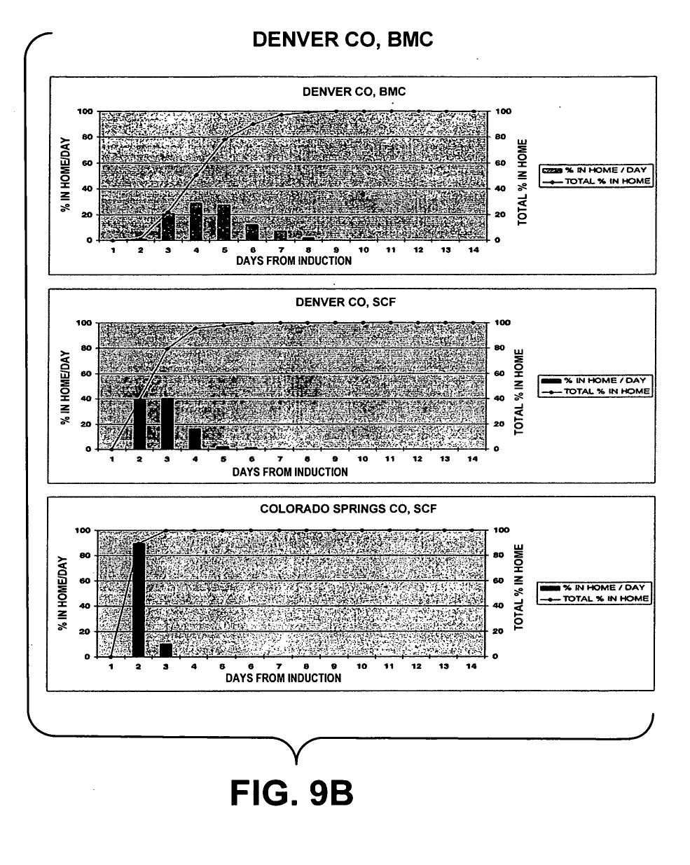

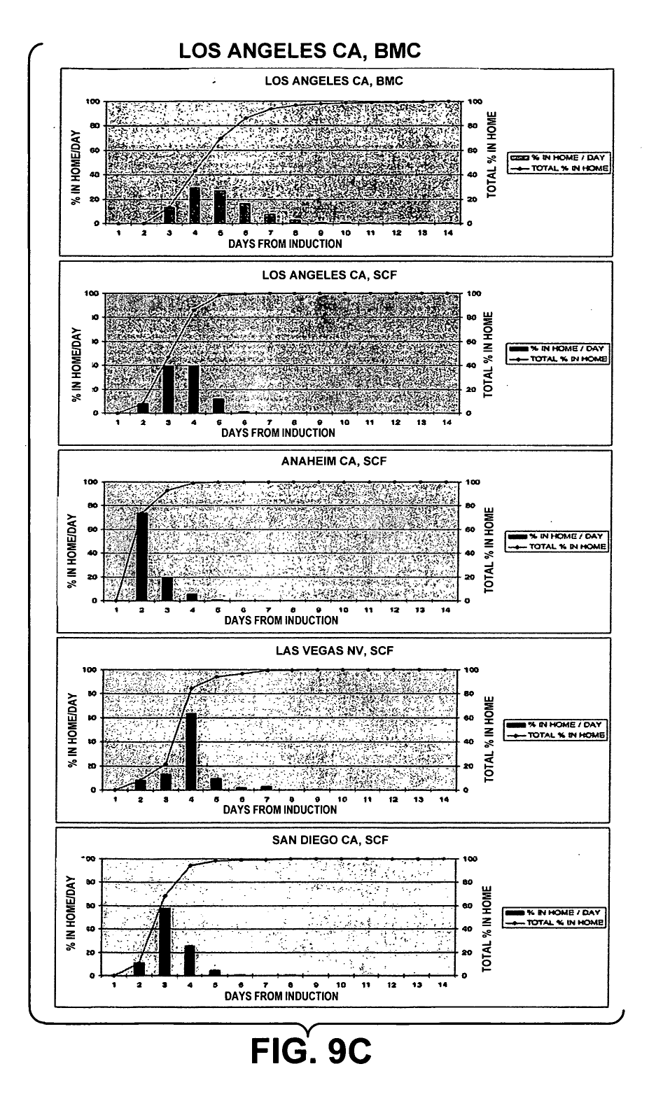

FIGS. 9A-9C show example curves generated for BMC's and SCF's in three different regions: Dallas Tex., Denver Colo., and Los Angeles, Calif. The curves show the high variability of in home mail distributions, both volumes and timing, across BMC and SCF in the same region. Furthermore, the figures also show the high variability across different BMC's and/or SCF across different regions.

Each of the FIGS. 9A-9C shows graphs for a specific facility, displaying average distribution of in home mail volumes from the day of induction to the day of delivery, over a 10 month period, January to October 2004. In each chart, the x axis is the number of days since induction and the y axis is the percentage of the mail delivered on that day.

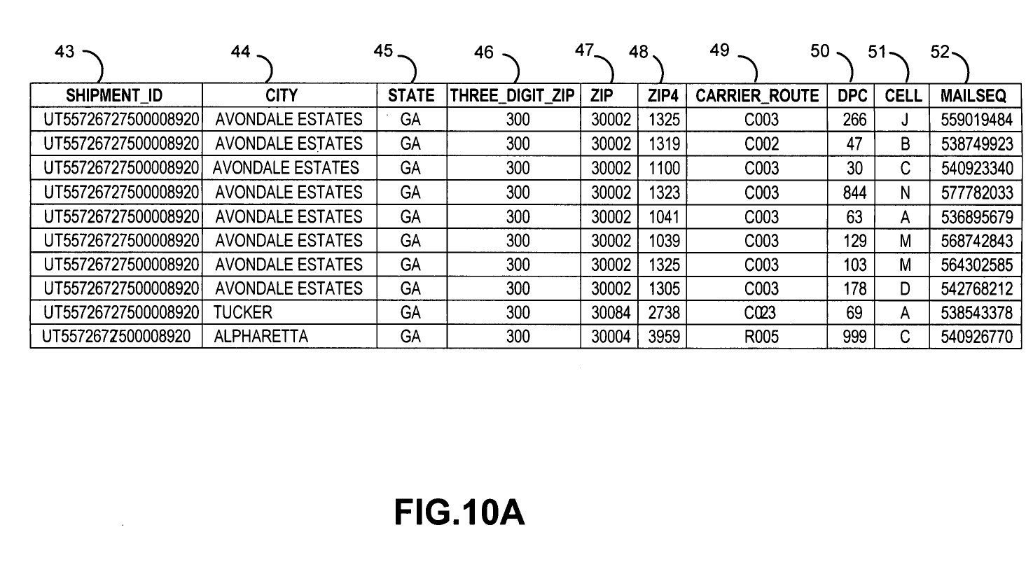

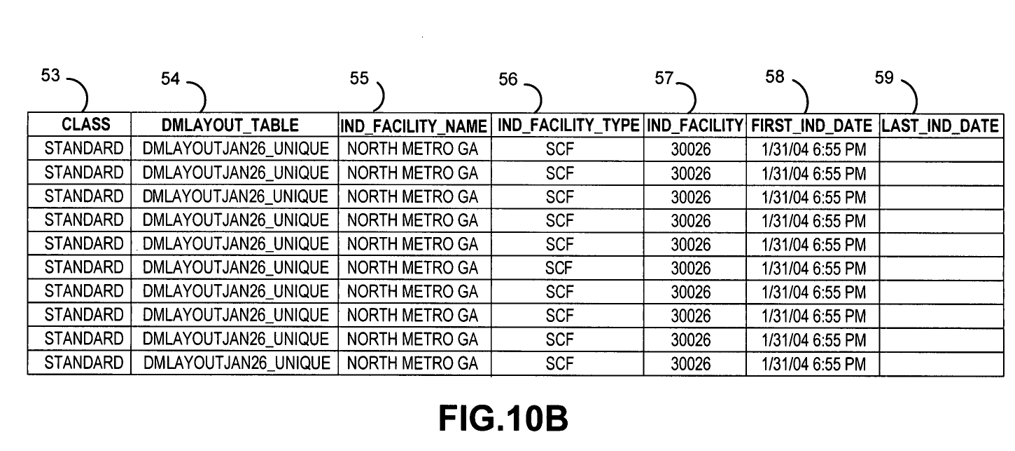

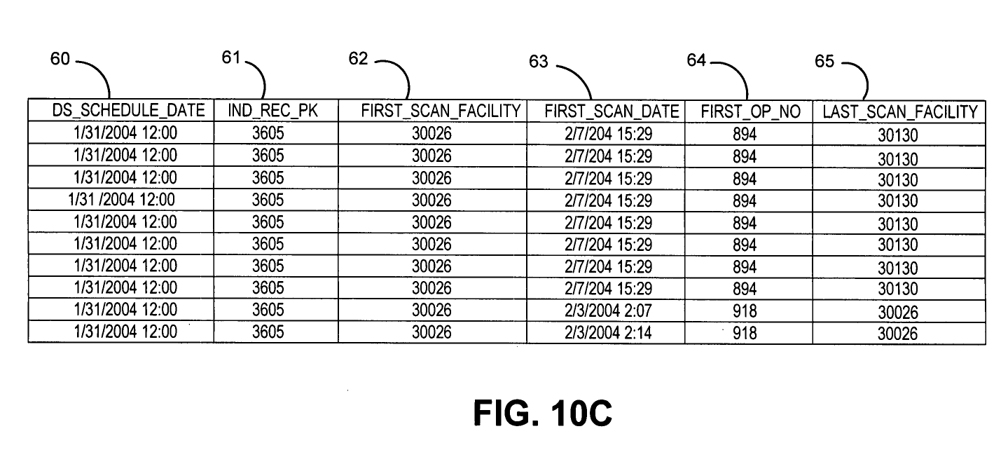

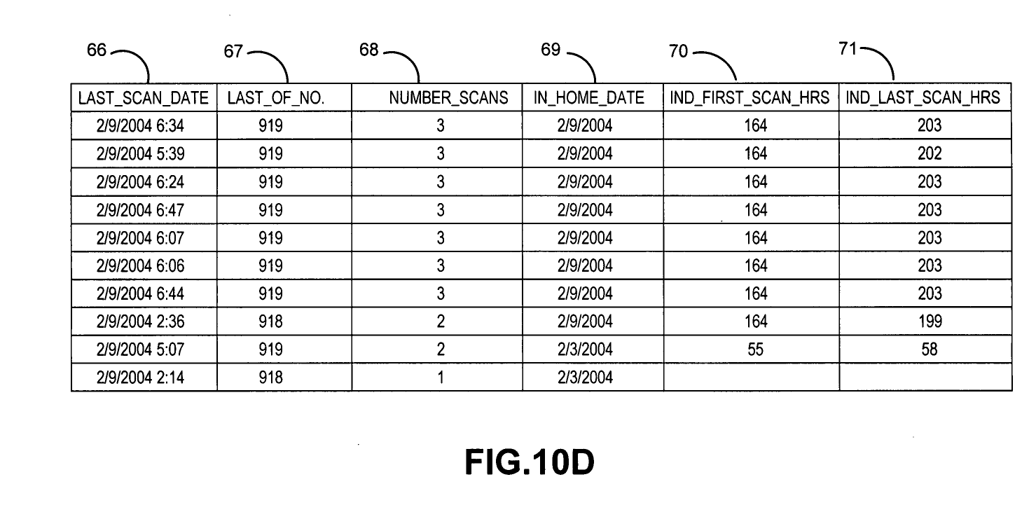

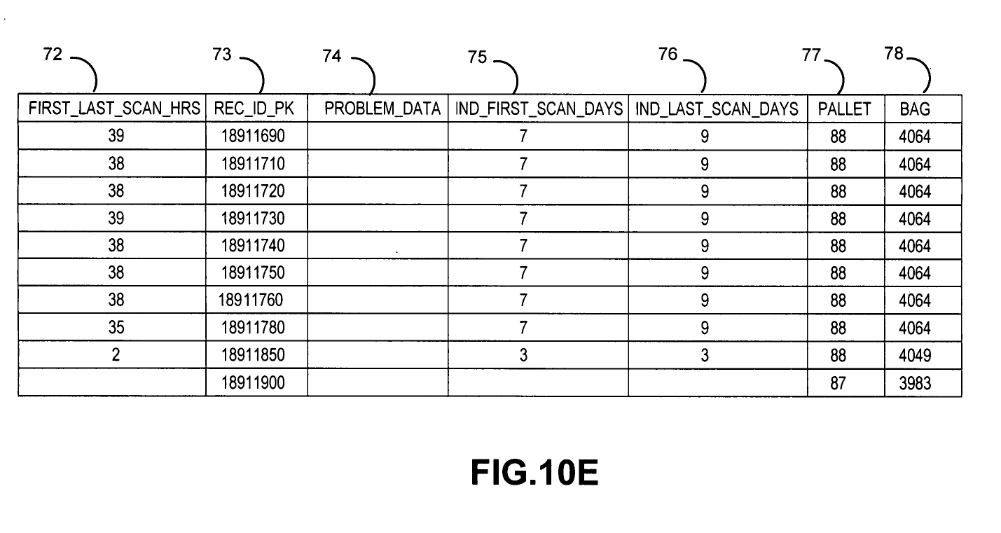

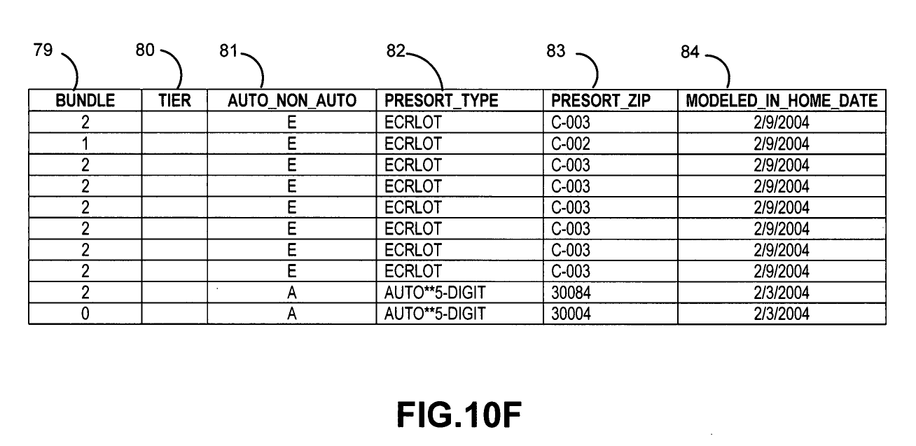

FIGS. 10A-10F is a table showing sample mail piece historic delivery times for the North Metro facility which is used to create container level data shown in step 1580 (FIG. 8).

In FIG. 10A the shipment ID, i.e., the identification of the mailing shipment is shown in column 43. The city and state that the shipment is delivered to is respectively shown in columns 44 and 45. The three digit zip code is shown in column 46. The zip code and the zip code plus four are respectively shown in columns 47 and 48. The carrier route for the shipment is shown in column 49. The delivery point code (DPC) is shown in column 50 and the cell i.e., identifies mail with different creative formats within a mailing is shown in column 51. The mail sequence i.e., internal/identifier for each mail piece is shown in column 52.

In FIG. 10 B the CLASS of mail is shown in column 53. Column 54 is the name DMLAYOUT_TABLE, the name of the table holding the address information for this mail piece. Column 55 (IND_FACILITY_NAME) holds the name of the induction facility. Column 56 (IND_FACILITY_TYPE) holds the type of facility, i.e. BMC, SCF, etc. Column 57 (IND_FACILITY) holds the zip code for the induction facility, and column 58 (FIRST_IND_DATE) is the time stamp of the first scan that occurs in the induction facility. Column 59 (LAST_IND_DATE) is the optional time stamp of the last scan that occurs in the induction facility.

In FIG. 10C column 60 (DS_SCHEDULE_DATE) is the date when the shipment was scheduled for drop shipment. Column 61 (IND_REC_PK) is a foreign key to the shipment record for this mail piece and column 62 (FIRST_SCAN_FACILITY) is the zip code of the facility where the mail piece was first scanned—after induction and column 63 (FIRST_SCAN_DATE) is the time stamp of the first scan at the processing facility. Column 64 (FIRST_OP_NO) is the operation that was performed on the mail piece during the first scan, i.e. first pass sort, second pass sort, etc. and column 65 (LAST_SCAN_FACILTY) is the zip code of the facility where the mail piece was last scanned.

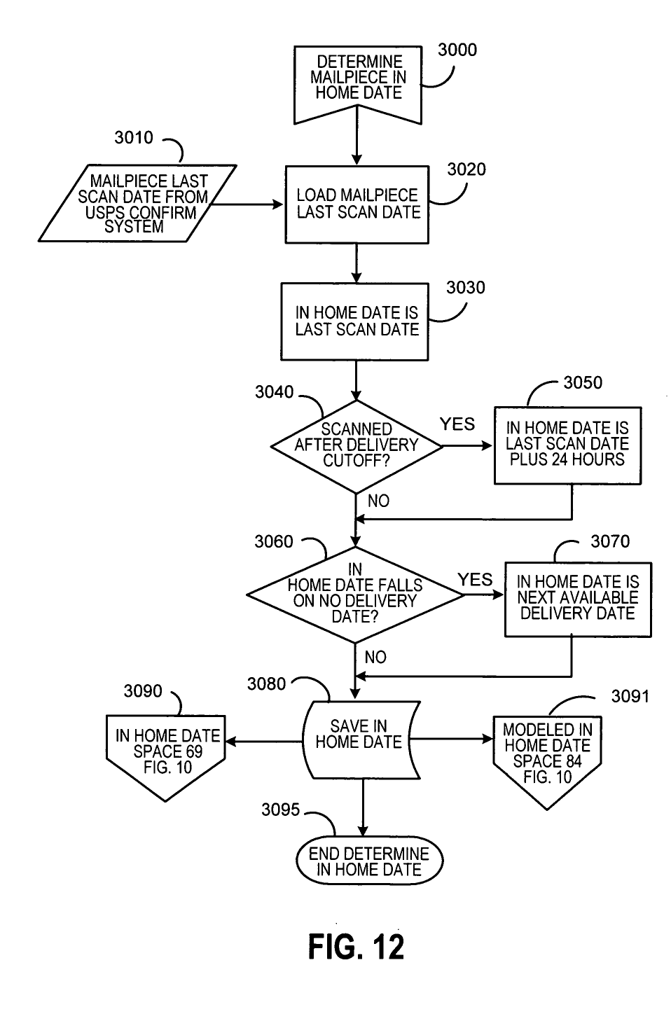

In FIG. 10D column 66 ((LAST_SCAN_DATE) is the time stamp of the last scan at a processing facility and column 67 (LAST_OP_NO) is the operation that was performed on the mail piece during the last scan. Column 68 (NUMBER_SCANS) is a count of the total number of planetcode scans (or operations) detected on the mail piece and column 69 (IN_HOME_DATE) is the calculated in home date for the mail piece, see FIG. 12. Column 70 (IND_FIRST_SCAN_HRS) is the number of hours between the FIRST_IND_DATE and the FIRST_SCAN_DATE and column 71 (IND_LAST_SCAN_HRS) is the number of hours between the FIRST_IND_DATE and the LAST_SCAN_DATE.

In FIG. 10E column 72 (FIRST_LAST_SCAN_HRS) is the number of hours between the FIRST_SCAN_DATE and the LAST_SCAN_DATE and column 73 (REC_ID_PK) is the primary key for this mail piece record. Column 74 (PROBLEM_DATA) is used to flag if there is problem data for this mail piece and Column 75 (IND_FIRST_SCAN_DAYS) is the IND_FIRST_SCAN_HRS represented as days. Column 76 (IND_LAST_SCAN_DAYS) is the IND_LAST_SCAN_HRS represented as days and column 77 (PALLET) identifies the pallet the mail piece is in for the mailing. Column 78 (BAG) identifies the bag the mail piece is in for the mailing.

In FIG. 10F column 79 (BUNDLE) identifies the bundle the mail piece is in Column 80 (TIER) i.e., C=carrier route, P=presort 3 or 5 digit, R=residential and column 81 (AUTO_NON_AUTO) indicates if the mail piece has an automation compatible post-net code, where A=zip code plus 4 plus 2 and N=zip code. Column 82 (PRESORT_TYPE) is the presort order assigned to the mail piece and column 83 (PRESORT_ZIP) is the zip code for the specific presort type in column 82. Column 84 (MODELED_IN_HOME_DATE) is the calculated in home date, see FIG. 12.

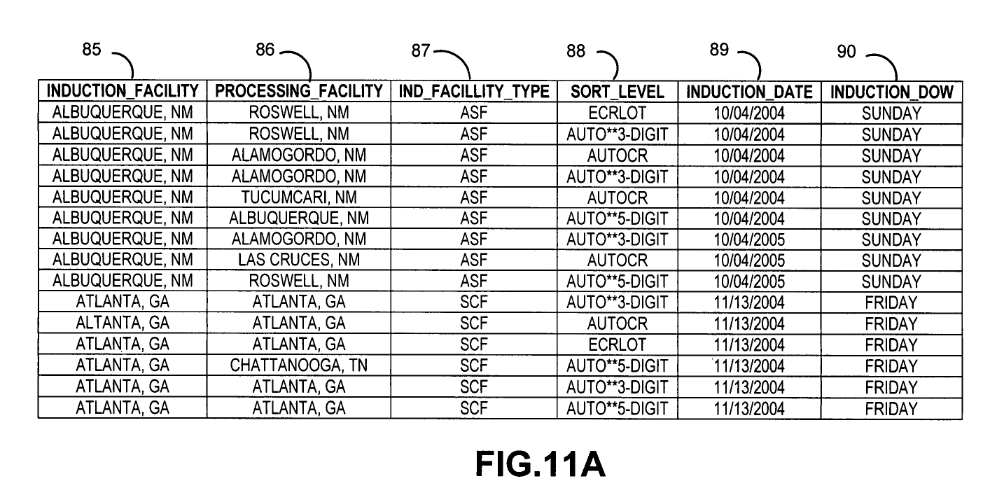

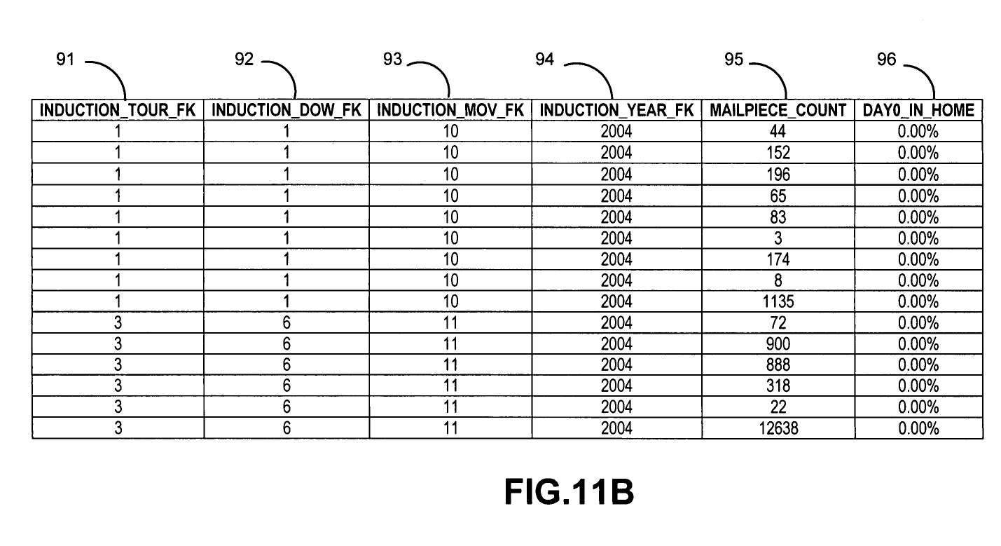

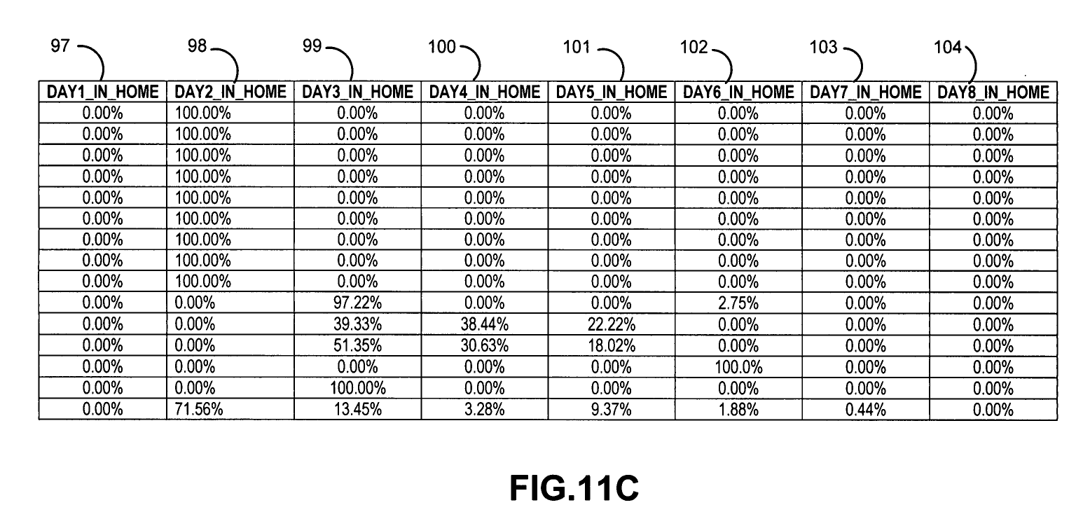

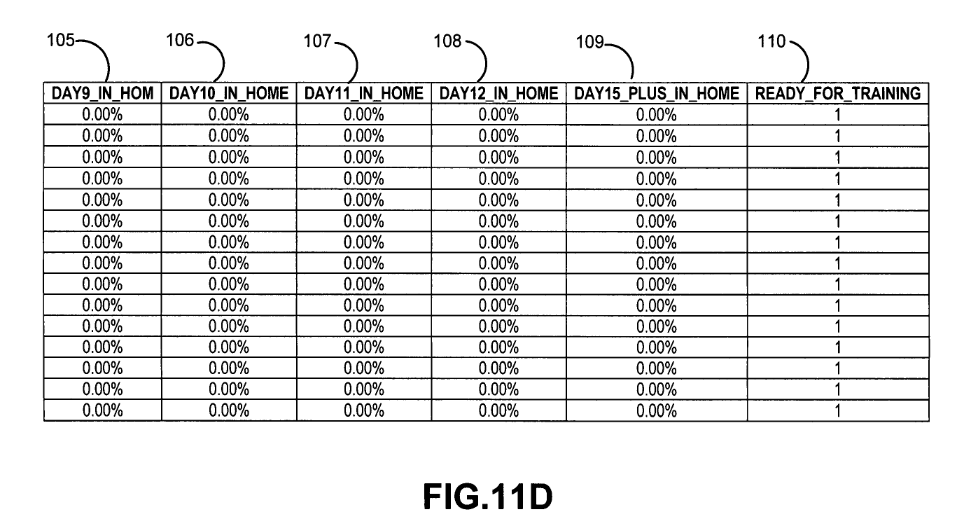

Mail piece level data (FIGS. 10A-10F) is combined or aggregated into container level data and tabulated as shown in FIGS. 11A-11D.

FIGS. 11A-11D depicts sample data representative of the mailing container level data shown in step 1580 (FIG. 8) in tabular form. In FIG. 11A the location of the induction facility for the mailing shipment is shown in column 85. Each row in FIGS. 11A-11D is representative of an aggregation of containers of mail pieces represented in rows in FIGS. 10A-10F (belonging to the container). The type of induction facility i.e., BMC, Auxiliary Sectional Facility (ASF) or SCF is shown in column 87. The sort level performed on the mail pieces, i.e., Enhanced Carrier Route (ECROLT), three digit sort level (AUTO**3-Digit), Auto Carrier Route (AUTOCR), five digit sort level (AUTO**5-Digit) are shown in column 88. The induction date of the shipment for the container is shown in column 89. The induction day of week (DOW) is shown in column 90.

In FIG. 11 B is the induction tour when the shipment was inducted Foreign Key (FK) for the container is shown in column 91 and the induction Day Of Week (DOW) for the container is shown in column 92. The location of the processing facility of the mailing shipment is shown in column 86. The induction MOY month of year (MOY) for the container is shown in column 93 and the induction year-FK for the container is shown in column 94. The mail piece count for the shipment is shown in column 95. The percentage of the container mail pieces that arrived on the induction day (Day0) In home is shown in column 96.

In FIG. 11 C the percent of mail pieces that are in the home one day after postal induction is shown in column 97 and the percent of mail pieces that are in the home two days after postal induction is shown in column 98. The percent of mail pieces that are in the home three days after postal induction is shown in column 99 and the percent of mail pieces that are in the home four days after postal induction is shown in column 100. The percent of mail pieces that are in the home five days after postal induction is shown in column 101 and the percent of mail pieces that are in the home six days after postal induction is shown in column 102. The percent of mail pieces that are in the home seven days after postal induction is shown in column 103 and the percent of mail pieces that are in the home eight days after postal induction is shown in column 104.

In FIG. 11D the percent of mail pieces that are in the home nine days after postal induction is shown in column 105 and the percent of mail pieces that are in the home ten days after postal induction is shown in column 106. The percent of mail pieces that are in the home eleven days after postal induction is shown in column 107 and the percent of mail pieces that are in the home twelve days after postal induction is shown in column 108. The percent of mail pieces that are in the home beyond the second week of postal induction is shown in column 109 and the ready for training flag shown in column 110 indicates when the record can be used as historical container level delivery curves as shown in step 1550 (FIG. 8).

FIG. 12 is a flowchart indicating how the In Home Date is calculated for a mail piece, and saved in space 69, IN_HOME_DATE, in FIG. 10D and is also used to calculate MODELED_IN_HOME_DATE in space 84 in FIG. 10F. The process is applied to each mail piece that is scanned and starts in step 3000 and is followed by step 3020, where the last scan for the mail piece is loaded from step 3010, Mail piece Last Scan Date from USPS Confirm System. Next, step 3030 initializes the In Home Date for the mail piece as the Last Scan Date and then if step 3040 determines if the mail piece scan occurred after the delivery cut-off time for that facility, step 3050 will add 24 hours to the in home date, since the mail piece will not be delivered on the same day. Next if step 3060 determines that the In Home Date falls on a no-delivery date, such as a Sunday, Holiday, or exception date, etc, step 3070 will use the next available delivery date is used as the In Home Date for the mail piece.

The process continues at step 3080 where the calculated In Home Date is saved to space 69 in FIG. 10D, as shown in step 3090. Finally, the process ends in step 3095.

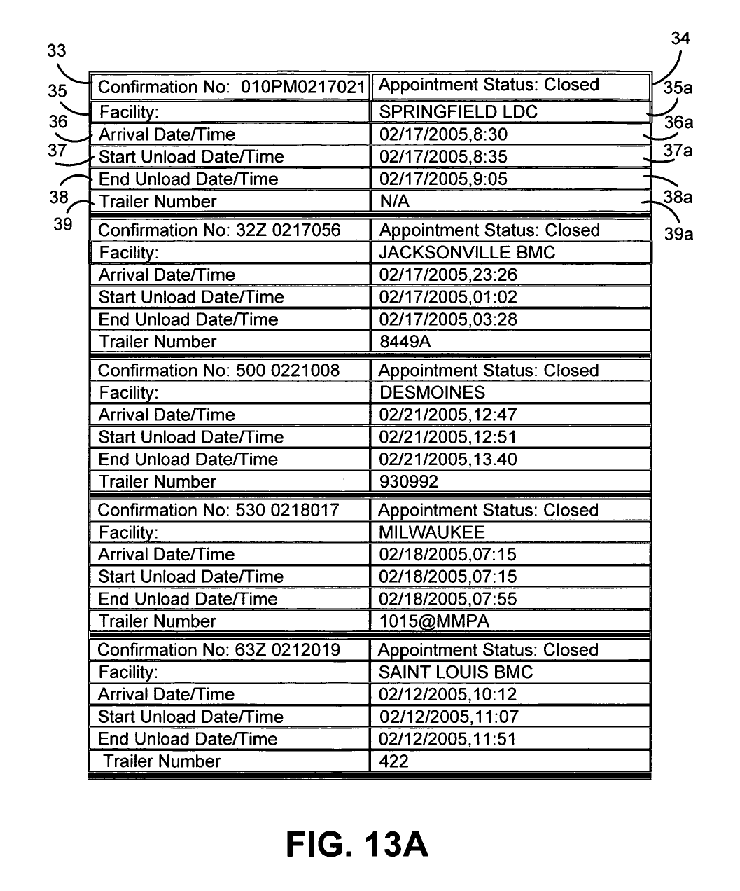

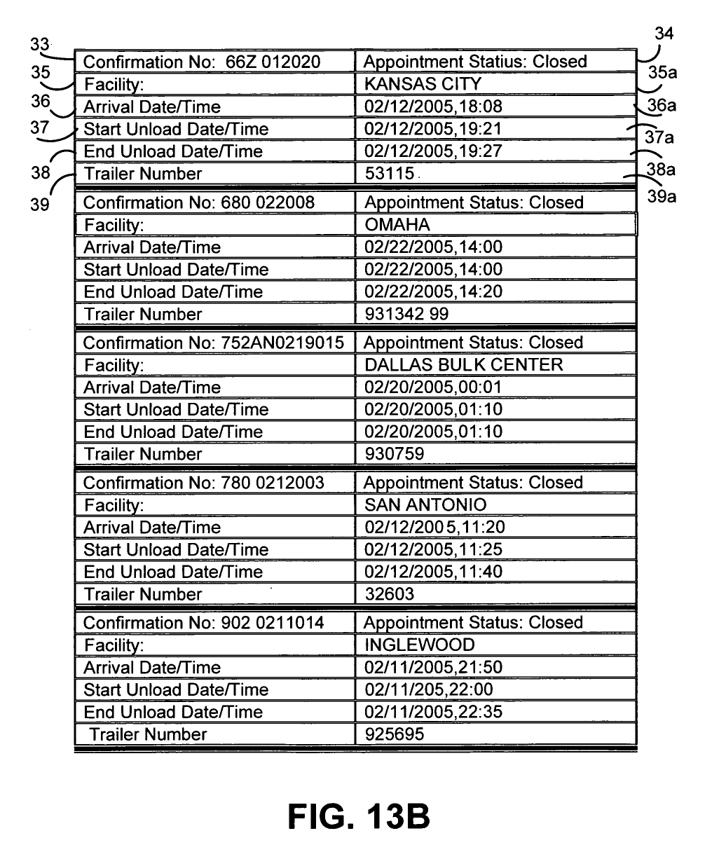

FIGS. 13A and 13B is a table of drop shipment appointment close out data, which is used to calculate the actual mail shipment induction date as described in FIG. 3. Space 33 indicates the shipment confirmation number and space 34 indicates the appointment status of the shipment, with states of Closed, No Show, or Open, etc. Space 35 indicates the header for space 35a, the name of the facility where the shipment is scheduled to arrive. Space 36 is the header for space 36a, the date and time when the truck arrived. Space 37 is the header for space 37a, the date and time when the truck started to be unloaded.

Space 38 is the header for space 38a, the date and time when the truck completed unloading. Space 39a is the header for Space 39a, the Trailer Number, identifying the truck that delivered the mail.

It should be understood that although the present invention was described with respect to mail processing by the USPS, the present invention is not so limited and can be utilized in any application in which mail is processed by any carrier. The present invention may also be utilized for mail other than direct marketing mail, for instance, transactional mail, i.e., bills, charitable solicitations, political solicitations, catalogues etc. Also the expression “in-home” refers to the recipient's residence or place of business.

The above specification describes a new and improved method for enabling a mailer to predict what volumes of mail will arrive at a recipient's home or place of business on a given date. It is realized that the above description may indicate to those skilled in the art additional ways in which the principles of this invention may be used without departing from the spirit. Therefore, it is intended that this invention be limited only by the scope of the appended claims.

What is claimed is:

1. A method utilizing a computer to predict what volumes of mail will arrive at a
given destination on a given date, comprising the steps of:
utilizing the composition of a mailing campaign that contains a plurality of mailing shipments that contain a plurality of containers containing a plurality of mail pieces;
making a prediction curve for each container in the shipments, wherein the shipments are inducted at a plurality of carrier facilities at different times; and building a mailing campaign prediction based upon the container prediction curves; wherein each container prediction curve is added to the mailing campaign prediction.

2. The method claimed in claim 1, wherein the container prediction curve is made on or before the induction of each of the containers at the plurality of carrier facilities.

3. The method claimed in claim 1, wherein the container prediction curve for each container is added to a mailing campaign prediction curve.

4. The method claimed in claim 3, wherein the container prediction curve for each container is added to a mailing campaign prediction curve at a known or anticipated carrier facility induction date.

5. The method claimed in claim 1, wherein the prediction curve for each container is determined by the induction date/time of the mail, the induction carrier facility, sort level of the mail, the mail type, the mail form and the mail campaign size.

6. The method claimed in claim 1, wherein the step of making a prediction curve, for each container further including the steps of:
aggregating historical mail piece data in order to determine delivery distribution patterns.

7. The method claimed in claim 1, wherein the mailing campaign prediction is used for marketing mail.

8. The method claimed in claim 1, wherein the mailing campaign prediction is used for transactional mail.

9. The method claimed in claim 1, further including the step of:
predicting a delivery pattern for specific carrier facilities.

10. The method claimed in claim 1, further including the step of:
predicting a delivery pattern for one or more of the carrier induction facilities.

11. The method claimed in claim 1, further including the step of:
predicting a delivery pattern for one or more of the carrier processing facilities.

12. The method claimed in claim 1, further including the step of:
predicting a delivery pattern for specific types of mail.

13. The method claimed in claim 1, further including the step of:
making a historical comparison on different mailing predictions over time.

14. The method claimed in claim 1, further including the step of:
making a prediction model that will generate container level predictions for the containers in each of the shipments in the mailing campaign.

15. The method claimed in claim 14, wherein the prediction model is used to build delivery patterns for one or more of the containers under different seasonal conditions.

16. The method claimed in claim 14, wherein the prediction model is used to build delivery patterns for one or more of the carrier facilities under different seasonal conditions.

17. The method claimed in claim 1, further including the step of:
applying a code to one or more mail pieces that identifies the mail piece.

18. The method claimed in claim 17, further including the step of:
receiving the date and time that the carrier scanned the codes.

19. The method claimed in claim 18, further including the step of:
using the date and time the carrier scanned the code to validate the container prediction curve.

20. The method claimed in claim 18, further including the step of:
using the date and time the carrier scanned the code to modify the container prediction curve.

21. The method claimed in claim 17, further including the step of:
receiving the date and time that each carrier facility processed the, shipment, container, or mail piece.

22. The method claimed in claim 21, further including the step of:
correlating the time, facility, operation performed, the codes applied to the mail pieces and the date and time that the mail piece was scanned

23. The method claimed in claim 1, further including the step of:
applying a code to one or more mail pieces that identifies an offer contained in the mail piece.

24. The method claimed in claim 1, further including the step of:
applying a code to one or more mail pieces that identifies a document contained in the mail piece.
